(19) United States
(12) Patent Application Publication
(10) Pub. No.: US 2026/0146632 A1
(43) Pub. Date: May 28, 2026

(54) SPLICING CONTAINER OF GAS TANK WITH MULTI-DIRECTIONAL LIMITING CONNECTION

(71) Applicant: Fujian Hongjun Furniture Co., Ltd., Zhangzhou (CN)

(72) Inventor: Shiyong WANG, Zhangzhou (CN)

(21) Appl. No.: 19/188,014

(22) Filed: Apr. 24, 2025

(30) Foreign Application Priority Data
Nov. 26, 2024 (CN) 202422892521.4

(51) Int. Cl. F16B 5/00

(52) U.S. Cl. CPC F16B 5/0084; F16B 5/0012

(57) ABSTRACT

A splicing container of gas tank with multi-directional limiting connection is provided and includes a top cover and more than two side plates. Top ends of the side plates are connected to a bottom end surface of the top cover. One or more splicing members are disposed at connecting position of the top cover and the side plate, and the spicing member includes a multi-directional pin and a multi-directional slot. The multi-directional pin has positioning plates in two or more directions, the multi-directional slot has installation grooves in two or more directions, and the positioning plates of the multi-directional pin in at least two directions are inserted in the installation grooves of the multi-directional slot. The top cover plate and the side plates provide at least two connected plates, the multi-directional pin and the multi-directional slot are disposed the at least two connected plates respectively.

### CROSS-REFERENCE TO RELATED APPLICATIONS

The present disclosure claims priority of Chinese Patent Application No. 202422892521.4, filed on Nov. 26, 2024, the entire contents of which are hereby incorporated by reference.

### TECHNICAL FIELD

The present application relates to the technical field of containers of gas tank, and in particular to a splicing container of gas tank with multi-directional limiting connection.

### BACKGROUND

Traditional furniture, such as cabinets, composed of multiple connected plates, generally employ connecting structures between the plates. The connecting structure mainly be mortise and tenon joint, splicing plate joint, or other auxiliary joint. The following is a detailed analysis of these connection structures and their shortcomings:

### I. Mortise and Tenon Joint

### Connecting Manner:

The mortise and tenon joint is a common connecting structure in traditional Chinese furniture. Various of components of the furniture are tightly combined and connected together through the exquisite and accurate mortise and tenon joints, thus forming a sturdy and firm integral one.

In furniture such as cabinets, a mortise and tenon joint is usually used for joining in a corner of the frame structure, for example for joining in a right-angle corner or an oblique-angle corner. Joint in the right-angle corner has highly stably, and generally employs straight tenons, dovetail tenons, etc.; Joint in the oblique-angle corner is aesthetically pleasing, but has lower strength and is complex to be manufactured.

### Shortcomings:

High manufacturing technology requirements: the production of mortise and tenon joint requires superb woodworking skills. If not properly controlled, it can easily lead to manufacturing deficiency, such as the tenon loosed and the tenon shoulder sawed crooked.

Relatively low manufacturing efficiency: compared with modern mechanical connecting ways, the mortise and tenon joint has relatively low production efficiency since the mortise and tenon joint should be manually manufactured.

### II. Splicing Plate Joint

### Connecting Manner:

The splicing plate joint is used to assemble narrow solid wood plates into plate with desired width, and is generally employed in solid wood table, solid wood door, and chair, etc.

In cabinets, the splicing plate joint is typically used to forming components such as front plates and side plates. A common splicing plate joint includes dragon and phoenix tenons, and straight tenon splicing plate with large thickness, etc.

### Shortcomings:

Prone to deform: due to the hygroscopic and drying properties of wood, splicing plate joint may deform after long-term used. Especially, two end surfaces of the splicing plate joint are prone to upwarp and even crack.

High requirements in material: in order to ensure the stability and aesthetics of the splicing plate joint, the components of a splicing plate should has the same wood species and moisture content.

### III. Other Auxiliary Joint

In traditional furniture, in addition to the mortise and tenon joint and splicing plate joint, other auxiliary joint, such as nail connections and glue connections, are also employed. These joints are typically employed to reinforce or repair the structure of furniture.

### Shortcomings:

Nail connection: wood fibers are liable to be damaged by the nail connections, thus affecting the stability of the wood. Moreover, when the nails crack or be loosened, a structural stability of the furniture decreases.

Glue connection: the glue may age and fail over time, which resulting in that components of the furniture loosen or fall off, though the glue connections can strengthen the structure of furniture.

In summary, joints, employed between plates and employed in traditional furniture consisting of multiple connected plates, each has its advantages and disadvantages. In practical applications, it is necessary to consider factors such as the usage requirements of the furniture, material properties, and production processes to select the appropriate joint. Also, in order to extend the service life of the furniture and maintain its aesthetics, it is also important to pay attention to regular maintenance of the furniture.

### SUMMARY

Based on the shortcomings of traditional connecting technology, the present disclose provides a splicing container of gas tank with multi-directional limiting connection that is highly efficient in assembly, stable in assembly, and convenient for maintenance.

To achieve the above object, a technical solution of the present disclose is:

A splicing container of gas tank with multi-directional limiting connection of including a top cover and more than two side plates. Top ends of the side plates being connected to a bottom end surface of the top cover. Wherein one or more splicing members are disposed at connecting position of the top cover and the side plate, and the spicing member comprises a multi-directional pin and a multi-directional slot. The multi-directional pin has positioning plates in two or more directions, the multi-directional slot has installation grooves in two or more directions, and the positioning plates of the multi-directional pin in at least two directions are inserted in the installation grooves of the multi-directional slot. At least two connected plates are provided by the top cover plate and the side plate, the multi-directional pin is disposed on one of the at least two connected plates, and the multi-directional slot is disposed on others of at least one two plates.

In one of the embodiments, the multi-directional slot has more than two positioning side posts and one or more positioning middle posts. The positioning plate of the multi-directional pin in one direction is inserted between one positioning side post and one positioning middle post.

In one of the embodiments, the multi-directional slot has two positioning side posts and two positioning middle posts.

In one of the embodiments, the multi-directional slot matches with two multi-directional pins.

In one of the embodiments, the multi-directional pin has an L-shaped pin and a top closing cover. The top closing cover is located at the top of the L-shaped pin and covers a lateral portion and a lengthways portion of the L-shaped pin. When the L-shaped pin is completely inserted into the multi-directional slot, the slot surface of the multi-directional slot resists the top closing cover, allowing the multi-directional pin detach from the multi-directional slot in a single direction at the initial stage of separation.

In one of the embodiments, the top cover has one or more multi-directional slots, and at least two side plates are provided with the multi-directional pins.

In one of the embodiments, the splicing member is a straight-through splicing member. The multi-directional pin of the straight-through splicing member has positioning plates in three directions, the multi-directional slot of the straight-through splicing member has installation grooves in three directions, and the three positioning plates match with the three installation grooves respectively, ensuring that the positioning plates of the multi-directional pin in at least two directions are inserted into the installation grooves of the multi-directional slot.

In one of the embodiments, the splicing member is a corner splicing member, the multi-directional pin of the corner splicing member has positioning plates in two directions, the multi-directional slot of the corner splicing member has installation grooves in two directions, and the three positioning plates match with the three installation grooves respectively, ensuring that the positioning plates of the multi-directional pin in at least two directions are inserted into the installation grooves of the multi-directional slot.

In one of the embodiments, the splicing container of gas tank with multi-directional limiting connection comprises four side plates and a top closing cover. One or more L-shaped multi-directional pins are disposed at the connecting position of the adjacent side plates other than the bottom and the top. The L-shaped multi-directional pin of the adjacent side plates are arranged side by side and match with the multi-directional slot of the corner splicing member. The top closing cover is disposed on a top of the L-shaped multi-directional pins.

In one of the embodiments, the splicing container of gas tank with multi-directional limiting connection further comprises a corner plate. The corner plate is assembled at the bottom of the connecting position of two adjacent side plates. The corner plate has the multi-directional slot, the adjacent side plates has the multi-directional pin matched with the multi-directional slot of the corner plate, and the multi-directional slot of the corner plate and the multi-directional pin matched with of the multi-directional slot of the corner plate cooperatively form the corner splicing member.

In one of the embodiments, the splicing member is a corner splicing member. The multi-directional pin of the corner splicing member comprises a lateral pin and a lengthways pin, and an angle between the lateral pin and the lengthways pin is 60 degrees, a multi-directional slot of the corner splicing member comprises a lateral slot and a lengthways slot, and an angle between the lateral slot and the lengthways slot is 60 degrees. The lateral pin matches with the lateral slot, and the lengthways pin matches with the lengthways slot.

In one of the embodiments, the multi-directional pin further comprises a top closing cover, the top closing cover is connected and located to a top of the lengthways pin; the multi-directional slot has two lateral slots and two lengthways slots.

In one of the embodiments, the multi-directional slot has two positioning side posts and two positioning middle post. The lateral pin and the lengthways pin are inserted between one positioning side post and two positioning middle post.

The beneficial aspects of the above technical solution are:
1. The present disclosure innovatively provides an engaging manner formed by multi-directional pins and multi-directional slots. There are an arbitrary number of connecting points between two plates connected to each other, and more importantly, each connecting point has limiting structures in more than two directions. Therefore, after assembly, the separation direction of the plates is unique, and the multi-directional pins and multi-directional slots can only be disassembled in this single direction. As a result, the assembly stability is far higher than that of traditional connection manners. Since the engaging manner formed by multi-directional pins and multi-directional slots is adopted, almost no professional tools are needed to be employed in assembly process. Therefore, users can assemble it by themselves, which greatly reduces the assembly cost of the factory. At the same time, it is also convenient for logistics in a disassembled state, greatly saving the occupation of transportation space.
2. The multi-directional slot of the present disclosure has more than two positioning side posts and one or more positioning middle posts. The positioning plate of the multi-directional pin in one direction is inserted between one positioning side post and one positioning middle post, which greatly improves the damage resistance of the multi-directional slot. Therefore, the number of times of being disassembled and reassembled is greatly increased, thereby enhancing the maintenance capability.
3. The multi-directional pin of the present disclosure has an L-shaped pin and a top closing cover, which greatly improves the assembly stability of the multi-directional pin and reduces the possibility of damage during being inserted into and pulled out of the multi-directional slot.
4. In the present disclosure, the positioning plates on at least two of the side plates extend along different directions, thus the side plates interlocking with each other to limiting positions thereof, thereby improving a stability of the present disclosure.

### BRIEF DESCRIPTION OF DRAWINGS

FIG. 1 is a schematic, upright view of a splicing container of gas tank with multi-directional limiting connection according to an Embodiment 1 of the present disclosure.

FIG. 2 is a schematic, inverted view of the splicing container of gas tank with multi-directional limiting connection of the Embodiment 1.

FIG. 3 is a schematic, exploded view of a straight-through splicing member of the Embodiment 1.

FIG. 4 is a schematic, exploded view of a corner splicing member of the Embodiment 1.

FIGS. 5-11 are schematic, partially assembled views of the Embodiment 1.

FIG. 12 is a schematic, inverted view of a multi-directional pin according to an Embodiment 2.

FIG. 13 is a schematic, upright view of the multi-directional pin of the Embodiment 2.

FIG. 14 is a schematic view of a multi-directional slot of the Embodiment 2.

### DESCRIPTION OF EMBODIMENTS

### Embodiment 1

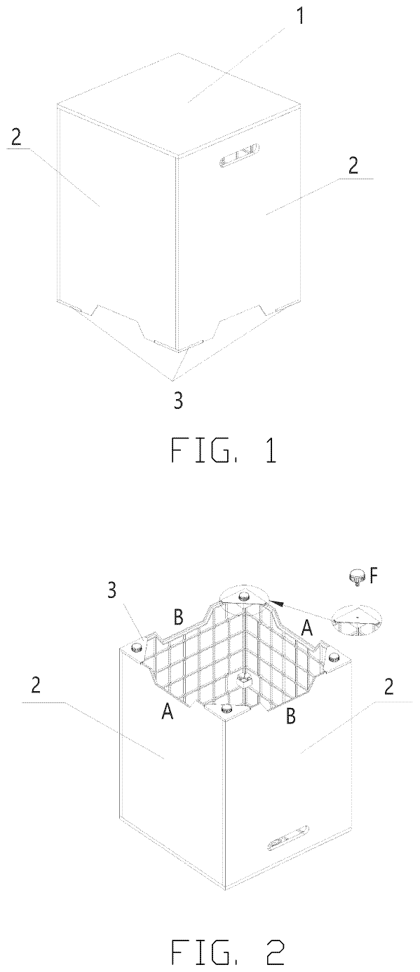

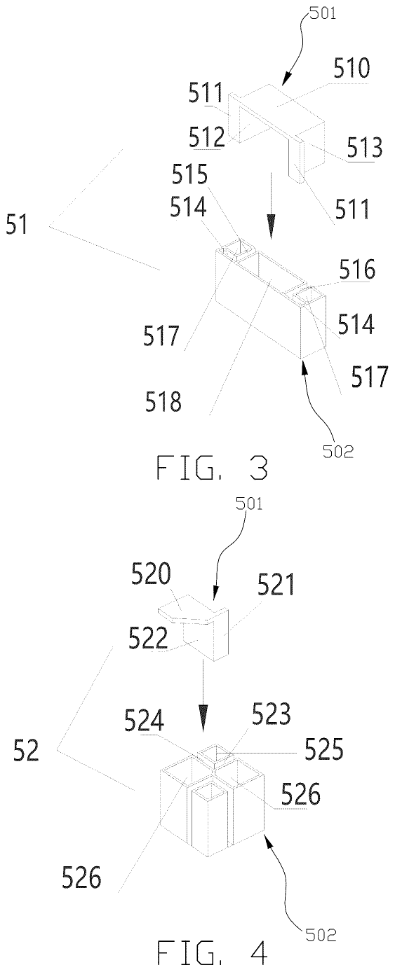

As shown in FIG. 1, a splicing container of gas tank with multi-directional limiting connection includes a top cover 1, four side plates 2 and four corner plates 3. Top ends of the side plates 2 are connected to a bottom end surface of the top cover 1. One straight-through splicing member 51 and two corner splicing members 52 are disposed at connecting position of the top cover 1 and the side plates 2 connected to each other. Each of the straight-through splicing member 51 and the corner splicing member 52 includes a multi-directional pin 501 and a multi-directional slot 502.

The multi-directional pin 501 of the straight-through splicing member 51 has positioning plates in three directions including a positioning plate 511, a positioning plate 512, and a positioning plate 513. The multi-directional slot 502 of the straight-through splicing member 51 has installation grooves in three directions including an installation groove 514, an installation groove 515 and an installation groove 516. Wherein, the positioning plate 511 matches with the installation groove 514, the positioning plate 512 matches with the installation groove 515, and the positioning plate 513 matches with the installation groove 516, ensuring that positioning plates of the multi-directional pin 501 in at least two directions are inserted into the installation grooves of the multi-directional slot 502. The multi-directional pin 501 of the straight-through splicing member 51 further has a top cover 510. The positioning plate 511 is connected to the positioning plate 512 and the positioning plate 513 respectively to form an L-shaped pin, and the top cover 510 is connected and located at the top of the positioning plate 512 and the positioning plate 513. The multi-directional slot 502 has two positioning side posts 517 and one positioning middle post 518, and the positioning plate 513 is inserted between one positioning side post 517 and the positioning middle post 518.

The multi-directional pin 501 of the corner splicing member 52 has positioning plates in two directions including a positioning plate 521 and a positioning plate 522. The multi-directional slot 502 of the corner splicing member 52 has installation grooves in two directions including an installation groove 523 and an installation groove 524. Wherein the positioning plate 521 matches with the installation groove 523, and the positioning plate 522 matches with the installation groove 524, ensuring that positioning plates of the multi-directional pin 501 in at least two directions are inserted into the installation grooves of the multi-directional slot 502. The multi-directional pin 501 of the corner splicing member 52 also has a top cover 520. The positioning plate 521 and the positioning 522 are connected each other to form an L-shaped pin, and the top cover plate 520 is connected and located at the top of the positioning plate 522. The multi-directional slot 502 has two positioning side posts 525 and two positioning middle posts 526, and the positioning plate 521 is inserted between one positioning side post 525 and the positioning middle post 526.

The corner plate 3 includes the multi-directional slot 502, and the multi-directional slot 502 is composed of two positioning side posts and two positioning middle posts. The corner plate 3 is assembled at the bottom of the connecting position of two adjacent side plates 2 (Side Plate A, Side Plate B). Each of the Side Plate A and the Side Plate B has the L-shaped multi-directional pin 501 matching with the multi-directional slot 501 of the corner plate 3. The corner plate 3 has a fastening screw F.

One or more L-shaped multi-directional pins 501 is disposed at the connecting position of adjacent side plates 2 (Side Plate A, Side Plate B) other than the bottom and the top. The L-shaped multi-directional pin 501 of the Side Plate A and the L-shaped multi-directional pin 501 of the Side Plate B are arranged side by side and match with the additional multi-directional slot D.

In this embodiment, at least two connected plates are provided by the above-described top cover plate 1 and side plates 2. The multi-directional pin 501 is disposed on one of the at least two connected plates, and the multi-directional slot 502 is disposed on others of at least one two plates.

As shown in FIG. 4, one multi-directional slot 502 is matched with two multi-directional pins 501.

In this embodiment, the slot surface of the multi-directional slot 502 resists the top closing cover, allowing the multi-directional pin 501 detach from the multi-directional slot 502 in a single direction at the initial stage of separation.

In this embodiment, the top cover includes one or more multi-directional slots 502, and the multi-directional pin 501 is formed on at least two side plates.

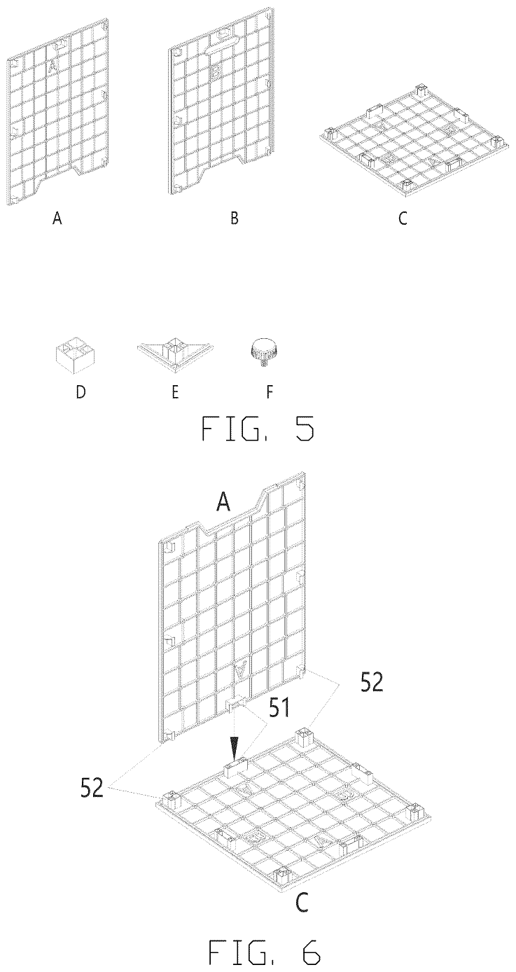

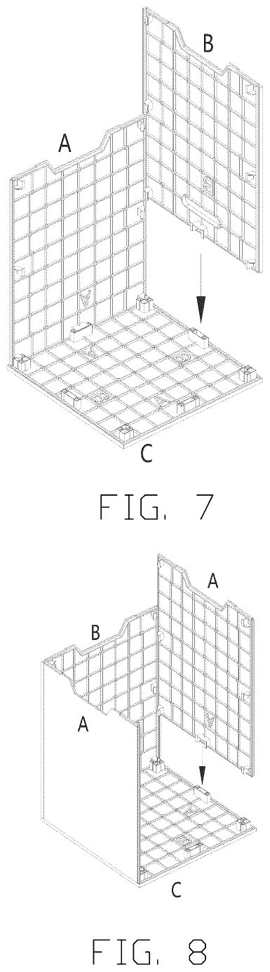

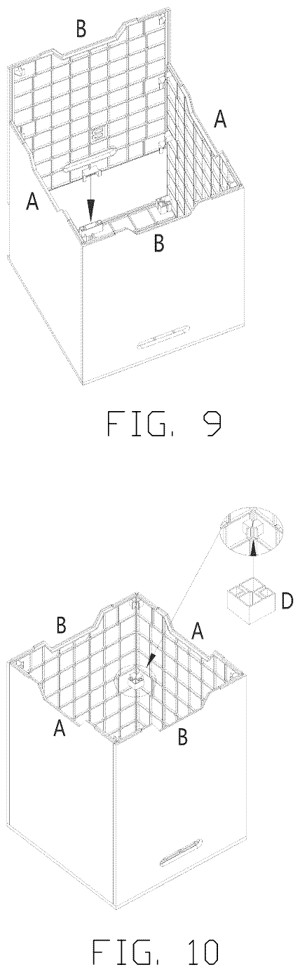

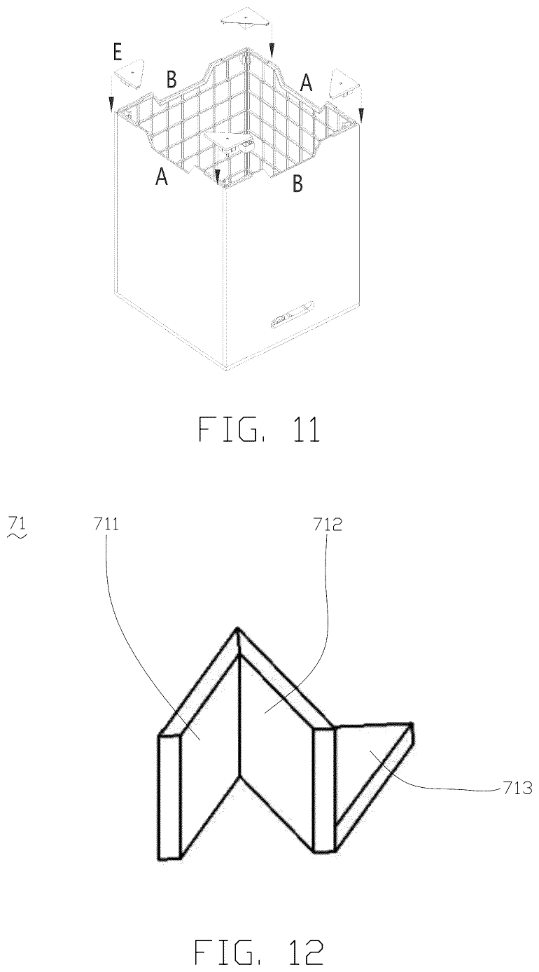

The assembly process of this embodiment is shown in FIG. 5, FIG. 6, FIG. 7, FIG. 8, FIG. 9, FIG. 10, FIG. 11, and FIG. 2 in that order.

The present disclosure innovatively provides an engaging solution of multi-directional pins and multi-directional slots. There are an arbitrary number of connecting points between two plates connected to each other, and more importantly, each connecting point has limiting structure in more than two directions. Therefore, after assembly, the separation direction of the plates is unique, and disassembly can only be carried out in this direction. As a result, the assembly stability is far higher than that of traditional connection solution. Since engaging solution of multi-directional pins and multi-directional slots is adopted, almost no professional tools are needed to be employed during the assembly process. Therefore, users can assemble it by themselves, which greatly reduces the assembly cost of the factory. At the same time, it is also convenient for logistics in a disassembled state, greatly saving the occupation of transportation space.

### Embodiment 2

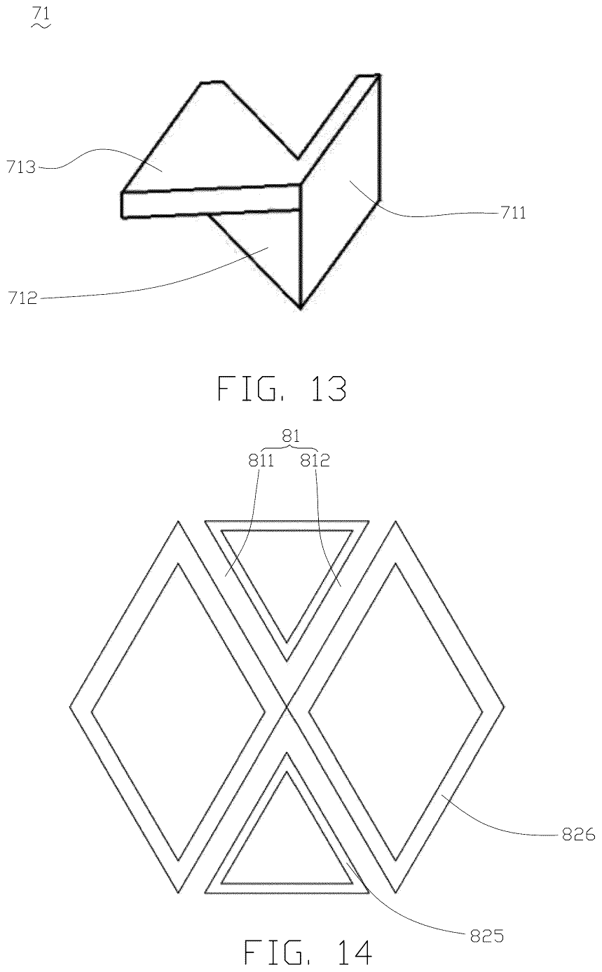

A splicing container of gas tank with multi-directional limiting connection of the Embodiment 2 includes six side plates. Referring to FIG. 12 and FIG. 13, a multi-directional pin 71 of a corner splicing member of the splicing container of gas tank with multi-directional limiting connection of the Embodiment 2 includes a lateral pin 711 and a lengthways pin 712, and an angle between the lateral pin 711 and the lengthways pin 712 is degrees. The multi-directional pin 71 further includes a top closing cover 713, and the top closing cover 713 is connected and located to a top of the lengthways pin 712. Referring to FIG. 14, a multi-directional slot 81 of the corner splicing member of the Embodiment 2 includes a lateral slot 811 and a lengthways slot 812, and an angle between the lateral slot 811 and the lengthways slot 812 is 60 degrees. The multi-directional slot 81 has two positioning side posts 825 and two positioning middle post 826, and the lateral pin 711 and the lengthways pin 712 are inserted between one positioning side post 825 and two positioning middle post 826. Specifically, the multi-directional slot 81 has two lateral slots 811 and two lengthways slots 812.

The above merely describes preferred embodiments of the present application without intention to limit the scope of the present application. Although the present application has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present application should be within the scope of the present application.

What is claimed is:

1. A splicing container of gas tank with multi-directional limiting connection comprising a top cover and more than two side plates with top ends of the side plates connected to a bottom end surface of the top cover, wherein one or more splicing members are disposed at connecting position of the top cover and the side plate, and the spicing member comprises a multi-directional pin and a multi-directional slot; the multi-directional pin has positioning plates in two or more directions, the multi-directional slot has installation grooves in two or more directions, and the positioning plates of the multi-directional pin in at least two directions are inserted in the installation grooves of the multi-directional slot; at least two connected plates are provided by the top cover plate and the side plate, the multi-directional pin is disposed on one of the at least two connected plates, and the multi-directional slot is disposed on others of at least one two plates.

2. The splicing container of gas tank with multi-directional limiting connection of claim 1, wherein the multi-directional slot has more than two positioning side posts and one or more positioning middle posts, and the positioning plate of the multi-directional pin in one direction is inserted between one positioning side post and one positioning middle post.

3. The splicing container of gas tank with multi-directional limiting connection of claim 2, wherein the multi-directional slot has two positioning side posts and two positioning middle posts.

4. The splicing container of gas tank with multi-directional limiting connection of claim 1, wherein the multi-directional slot matches with two multi-directional pins.

5. The splicing container of gas tank with multi-directional limiting connection of claim 3, wherein the multi-directional pin has an L-shaped pin and a top closing cover, the top closing cover is located at the top of the L-shaped pin and covers a lateral portion and a lengthways portion of the L-shaped pin, when the L-shaped pin is completely inserted into the multi-directional slot, the slot surface of the multi-directional slot resists the top closing cover, allowing the multi-directional pin detach from the multi-directional slot in a single direction at the initial stage of separation.

6. The splicing container of gas tank with multi-directional limiting connection of claim 1, wherein the top cover has one or more multi-directional slots, and at least two side plates are provided with the multi-directional pins.

7. The splicing container of gas tank with multi-directional limiting connection of claim 1, wherein the splicing member is a straight-through splicing member, the multi-directional pin of the straight-through splicing member has positioning plates in three directions, the multi-directional slot of the straight-through splicing member has installation grooves in three directions, and the three positioning plates match with the three installation grooves respectively, ensuring that the positioning plates of the multi-directional pin in at least two directions are inserted into the installation grooves of the multi-directional slot.

8. The splicing container of gas tank with multi-directional limiting connection of claim 7, wherein the splicing member is a corner splicing member, the multi-directional pin of the corner splicing member has positioning plates in two directions, the multi-directional slot of the corner splicing member has installation grooves in two directions, and the three positioning plates match with the three installation grooves respectively, ensuring that the positioning plates of the multi-directional pin in at least two directions are inserted into the installation grooves of the multi-directional slot.

9. The splicing container of gas tank with multi-directional limiting connection of claim 8, wherein the splicing container of gas tank with multi-directional limiting connection comprises four side plates and a top closing cover, one or more L-shaped multi-directional pins are disposed at the connecting position of the adjacent side plates other than the bottom and the top, the L-shaped multi-directional pin of the adjacent side plates are arranged side by side and match with the multi-directional slot of the corner splicing member, and the top closing cover is disposed on a top of the L-shaped multi-directional pins.

10. The splicing container of gas tank with multi-directional limiting connection of claim 9, wherein the splicing container of gas tank with multi-directional limiting connection further comprises a corner plate, the corner plate is assembled at the bottom of the connecting position of two adjacent side plates, the corner plate has the multi-directional slot, the adjacent side plates has the multi-directional pin matched with the multi-directional slot of the corner plate, and the multi-directional slot of the corner plate and the multi-directional pin matched with of the multi-directional slot of the corner plate cooperatively form the corner splicing member.

11. The splicing container of gas tank with multi-directional limiting connection of claim 1, wherein the splicing member is a corner splicing member, the multi-directional pin of the corner splicing member comprises a lateral pin and a lengthways pin, and an angle between the lateral pin and the lengthways pin is 60 degrees, a multi-directional slot of the corner splicing member comprises a lateral slot and a lengthways slot, and an angle between the lateral slot and the lengthways slot is 60 degrees; the lateral pin matches with the lateral slot, and the lengthways pin matches with the lengthways slot.

12. The splicing container of gas tank with multi-directional limiting connection of claim 11, wherein the multi-directional pin further comprises a top closing cover, the top closing cover is connected and located to a top of the lengthways pin; the multi-directional slot has two lateral slots and two lengthways slots.

13. The splicing container of gas tank with multi-directional limiting connection of claim 11, wherein the multi-directional slot has two positioning side posts and two positioning middle post, and the lateral pin and the lengthways pin are inserted between one positioning side post and two positioning middle post.

14. The splicing container of gas tank with multi-directional limiting connection of claim 1, the positioning plates on at least two of the side plates extend along different directions.
